(19) United States
(12) Patent Application Publication
(10) Pub. No.: US 2018/0302956 A1
(43) Pub. Date: Oct. 18, 2018

(54) METHOD AND APPARATUS OF APPLYING A SECONDARY SUBSTANCE TO A PRIMARY HEATABLE LOAD

(71) Applicant: Silicon Valley Factory LLC, Los Altos Hills, CA (US)

(72) Inventors: Sebastian Thrun, Los Altos, CA (US); David St. Martin, San Rafael, CA (US); Arash Kani, Roxbury, MA (US)

(21) Appl. No.: 15/489,483

(22) Filed: Apr. 17, 2017

(51) Int. Cl. H05B 6/64; A47J 27/00; G06K 7/10

(52) U.S. Cl. CPC H05B 6/6447; G06K 7/10861; A47J 27/002; H05B 6/645

(57) ABSTRACT

In various embodiments, an apparatus includes a receptacle for a primary heatable load and a secondary container having a portal region. The portal region can be actuated in response to a trigger such that at least a portion of contents of the secondary container is automatically dispersed to the primary heatable load from the portal region. In various embodiments, a method includes using a tag reader to read heating instruction data encoded in an electronic tag. The method includes determining heating phases and a trigger based on the read heating instruction data. For example, the trigger actuates a portal region to automatically disperse at least a portion of contents of a secondary container to a primary heatable load. The method includes automatically controlling a heating apparatus to execute the determined heating phases including actuation of the portal region in response to the trigger.

### BACKGROUND OF THE INVENTION

There are many challenges in food preparation. Cooking can be time-consuming and messy. For example, ingredient selection, acquisition, transportation, and preparation can be inconvenient. In spite of the effort expended, sometimes the results of meal preparation are unsatisfying. Successfully extracting flavors from ingredients typically requires lengthy cooking processes such as stewing or skilled processes such as browning. The final tastiness of food depends on the characteristics of the ingredients and a person's tastes and preferences.

Various types of cooking devices are available. For example, slow-cookers and pressure-cookers may simplify food preparation by facilitating unattended cooking. However, conventional slow-cookers are typically slow and limited to specific cooking techniques, e.g., simmering at low heat. Conventional pressure-cookers typically reduce cooking time. However, conventional pressure-cooking requires liquid and is not suitable for some techniques such as roasting or frying. Also, the time needed to pressurize and de-pressurize the cooking chamber can be time-consuming. Both slow cookers and pressure-cookers also typically require a cook to prepare (e.g., slice and portion) the ingredients.

Pre-packaged chilled convenience meals have been popular since the 1950s for its ease of preparation. Typical convenience meals are packaged in a tray and frozen. The consumer heats the meal in an oven or microwave and consumes the food directly from the tray. However, conventional pre-packaged convenience meals might be unhealthy and not tasty, and results may vary depending on the microwave or oven used to heat the meal. For example, sauces for the food can only be applied before the heating begins or after the heating ends and typically requires human intervention to apply the sauce.

### BRIEF DESCRIPTION OF THE DRAWINGS

Various embodiments of the invention are disclosed in the following detailed description and the accompanying drawings.

FIG. 1 is a block diagram illustrating an embodiment of an apparatus to apply a secondary substance to matter.

FIG. 2 is a block diagram illustrating an embodiment of an apparatus for heating.

FIG. 3 is a block diagram illustrating an embodiment of an apparatus to apply a secondary substance to matter.

FIG. 4 is a block diagram illustrating an embodiment of an apparatus to apply a secondary substance to matter.

FIG. 5 is a block diagram of an embodiment of a controller for a heating apparatus.

FIG. 6 is a flowchart illustrating an embodiment of a process to operate an automatic heating system.

FIG. 7 is a functional diagram illustrating a programmed computer system for applying a secondary substance to a primary heatable load in accordance with some embodiments.

FIG. 8 is a flowchart illustrating an embodiment of a process to apply a secondary substance to a primary heatable load.

FIG. 9 is a block diagram illustrating an embodiment of a heating schedule including a trigger for applying a secondary substance to a primary heatable load.

FIG. 10A is a block diagram illustrating an embodiment of a modular heating system.

FIG. 10B is a block diagram illustrating an embodiment of a modular heating system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A method and apparatus of applying a secondary substance to a primary heatable load is disclosed. In various embodiments, an apparatus includes a receptacle for a primary heatable load (e.g., food) and a secondary container having a portal region. The portal region can be actuated in response to a trigger such that at least a portion of contents (e.g., sauce) of the secondary container is automatically dispersed to the primary heatable load from the portal region. In various embodiments, a method includes using a tag reader to read heating instruction data encoded in an electronic tag (where the tag may be provided with the apparatus). The method includes determining heating phases and a trigger based on the read heating instruction data. For example, the trigger actuates a portal region to automatically disperse at least a portion of contents of a secondary container to a primary heatable load. The method includes automatically controlling a heating apparatus to execute the determined heating phases including actuation of the portal region in response to the trigger.

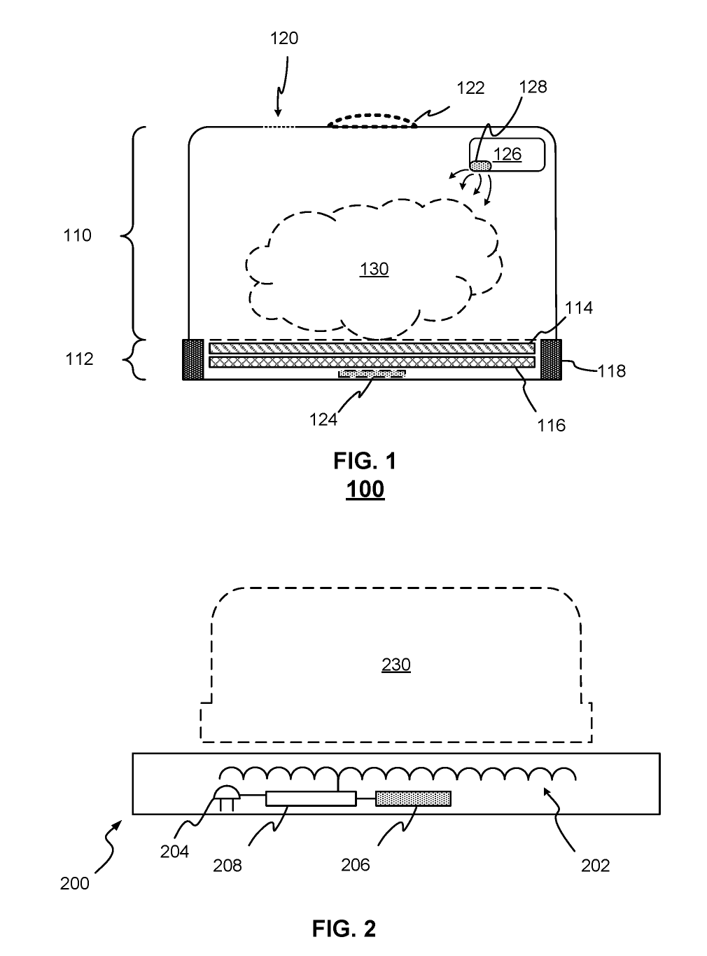

FIG. 1 is a block diagram illustrating an embodiment of an apparatus 100 to apply a secondary substance to matter 130. For example, in various embodiments the apparatus 100 includes a receptacle for matter 130 and a secondary container 126, where the secondary substance is provided in the secondary container. In various embodiments, the apparatus is adapted to store and transport matter 130 comprising food or other heatable loads (also referred to as “primary heatable load”) and secondary container 126. The apparatus 100 includes a receptacle (defined by a top portion 110 and a bottom portion 112), a metal layer 114, a membrane 116, a seal 118, a pressure relief valve 120, and secondary container 126.

The bottom portion 112 is adapted to receive matter 130. The bottom portion holds food or other types of loads. For example, the bottom portion may be a plate or bowl. As further described herein, a user may directly consume the matter 130 from the bottom portion 112.

The top portion 110 is adapted to fit the bottom portion 112 to form a chamber. For example, the top portion may be a cover for the bottom portion. In some embodiments, the top portion is deeper than the bottom portion and is a dome, cloche, or other shape. Although not shown, in some embodiments, the top portion is shallower than the bottom portion. In some embodiments, the top portion is transparent and the matter 130 can be observed during a preparation/heating process. In some embodiments, the chamber is at least partially opaque. For example, portions of the chamber may be opaque to prevent users from inadvertently touching the apparatus when the chamber is hot.

The top portion 110 and the bottom portion 112 may be made of a variety of materials. Materials may include glass, plastic, metal, compostable/fiber-based materials, or a combination of materials. The top portion 110 and the bottom portion 112 may be made of the same material or different materials. For example, the top portion 110 is metal while the bottom portion 112 is another material.

The seal 118 is adapted to join the top portion 110 to the bottom portion 112. In one aspect, the seal may provide an air-tight connection between the top portion and the bottom portion, defining a space enclosed within the top portion and the bottom portion. In some embodiments, in the space, matter 130 is isolated from an outside environment. The pressure inside the space may be different from atmospheric pressure. The seal may also prevent leakage and facilitate pressure buildup within the chamber in conjunction with pressure relief valve 120 and/or clamp 614.1, 614.2 of the heating apparatus of FIGS. 6A and 6B as further described herein.

In one aspect, a chamber formed by the top portion 110 and the bottom portion 112 may store and/or preserve food. For example, food may be vacuum-sealed inside the chamber. In another aspect, the chamber contains the food during a heating process. In various embodiments, the chamber can be directly be placed on a heating apparatus. For example, a user may obtain the chamber from a distributor (e.g., a grocery store), heat up the contents of the chamber without opening the chamber, and consume the contents of the chamber directly. In various embodiments, the same chamber stores/preserves food, is a transport vessel for the food, can be used to cook the food, and the food can be directly consumed from the chamber after preparation.

The metal layer 114 (also referred to as a conductive structure) heats in response to an EM source. In some embodiments, the metal layer heats by electromagnetic induction. The metal layer can heat matter 130. For example, heat in the metal layer may be conducted to the contents. As further described herein, the heating of the matter (in some cases in combination with a controlled level of moisture) in the chamber allows for a variety of preparation methods including dry heat methods such as baking/roasting, broiling, grilling, sauteing/frying; moist heat methods such as steaming, poaching/simmering, boiling; and combination methods such as braising and stewing. In various embodiments, several different heating methods are used in a single preparation process, e.g., the preparation process comprising a sequence of heating cycles.

The metal layer may be made of a variety of materials. In some embodiments, the metal layer includes an electrically conducting material such as a ferromagnetic metal, e.g., stainless steel. In various embodiments, the metal is processed and/or treated in various ways. For example, in some embodiments, the metal is ceramic-coated. In some embodiments, the metal layer is made of any metallic material, e.g., aluminum.

The membrane 116 (also referred to as a membrane region) is adapted to control an amount of liquid. For example, the membrane may provide controlled flow of moisture through the membrane. In various embodiments, the membrane may release liquids (e.g., water) inside a space defined by the top portion 110 and the bottom portion 112. For example, water can be released in a controlled manner and transformed to steam during a heating process. In various embodiments, the membrane may absorb liquids. For example, the membrane may absorb juices released by food during a heating process.

In some embodiments, the membrane 116 is adapted to provide insulation between the metal layer 114 and a surface of the bottom portion 112. For example, if the bottom portion is a glass plate, the membrane may prevent the glass plate from breaking due to heat.

The membrane 116 may be made of a variety of materials. In some embodiments, the membrane includes a heat-resistant spongy material such as open-cell silicone. In some embodiments, the membrane includes natural fiber and/or cellulose. The material may be selected based on desired performance, e.g., if the membrane is intended to absorb liquid or release liquid, a rate at which liquid should be absorbed/released, a quantity of liquid initially injected in the membrane, etc.

The pressure relief valve 120 regulates pressure in a space defined by the top portion 110 and the bottom portion 112. In various embodiments, the pressure relief valve relieves pressure buildup within the chamber. For example, in various embodiments the valve activates/deploys automatically in response to sensed temperature or pressure inside the chamber meeting a threshold. In some embodiments, the valve is activated by a heating apparatus such as heating apparatus 200 of FIG. 2. For example, the valve may be activated at a particular stage or time during a cooking process. The pressure relief valve allows the contents of the chamber to be heated at one or more pre-determined pressures including at atmospheric pressure. In various embodiments, this accommodates pressure heating techniques.

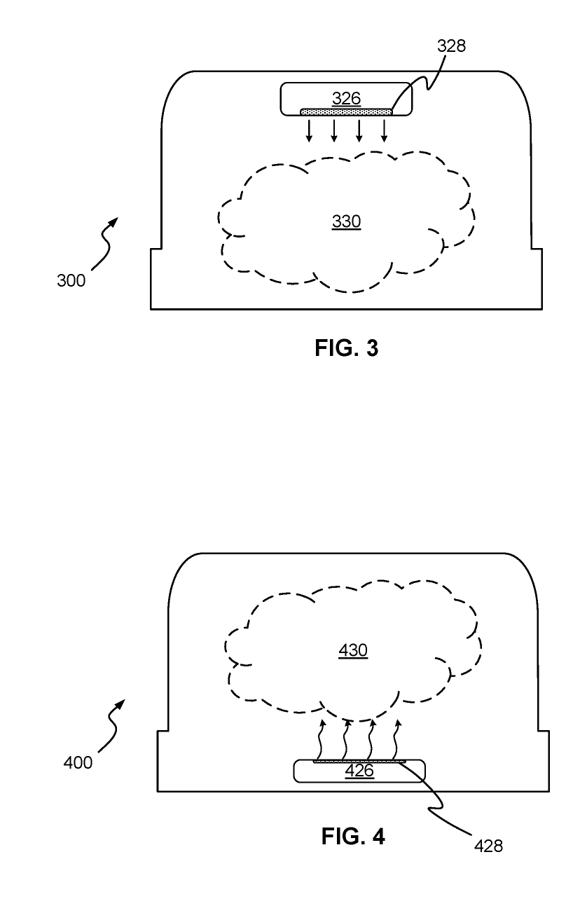

The secondary container 126 is adapted to hold and dispense a secondary substance. The secondary container may be packaged inside a space defined by top portion 110 and bottom portion 112. For example, the secondary container may be provided substantially above a primary heatable load as shown. In various embodiments, the secondary container may be removably attached to a wall or other component of apparatus 100. For example, the secondary container may be affixed by an adhesive or other mechanism. In various embodiments, the secondary container may be fixedly attached to a wall or other component of apparatus 100. For example, the secondary container may be mounted to the apparatus and later recycled or reused. The determination of whether the secondary container is to be fixedly or movably attached to the apparatus 100 may depend on a material of the secondary container and/or the secondary substance. For example, if the secondary container is made of a biodegradable material that dissolves during the heating process, the secondary container is movably mounted to the apparatus. Other example materials of the secondary container are further described herein. In the example of FIG. 1, the secondary container is provided in the top right corner of apparatus 100. In other embodiments, the secondary container may be provided elsewhere. Other example positions are shown in FIGS. 3 and 4.

The secondary container 126 may have a portal region 128. In various embodiments, the portal region is an area where the secondary substance can emerge. For example, the portal region may be actuated in response to a trigger such that at least a portion of contents of the secondary container (e.g., the secondary substance) is automatically dispersed to the primary heatable load 130 from the portal region 128.

The secondary substance may be dispersed in a pre-defined direction. That is, in various embodiments, the secondary substance is provided at a controlled angle. This facilitates provision of the secondary substance over a selected/desired portion of the primary heatable load, and may minimize waste of the secondary substance. The direction of dispersal may be controlled by one or more of the following: sizing of the portal region, shape of the portal region, material of the portal region and/or secondary container, one or more channels or ridges provided inside the secondary container, a spout in the portal region, providing a sieve in the portal region with variable filter size or hole size, and the like.

The secondary substance may be any solid or liquid substance mixed with a primary heatable load as part of a heating process. For example, the secondary substance may be a sauce (e.g., pasta sauce, cheese sauce, etc.), water, garnish or topping, seasoning (e.g., spices, herbs), among other things.

In various embodiments, the secondary substance is dispersed in response to a trigger. For example, the trigger causes the portal region to be actuated and at least a portion of contents of the secondary container to be automatically dispersed to the primary heatable load from the portal region. The trigger may impair a structural integrity of the portal region to cause the secondary substance to emerge from that region.

In various embodiments, the trigger is a temperature. The portal region 120 may respond to a temperature change. For example, the material or portion (e.g., a seal) of the portal region may break or melt at a threshold temperature. In various embodiments, the trigger is water or moisture content in a space defined by top portion 110 and bottom portion 120. For example, a portal region made of paper may break at a threshold humidity. In various embodiments, the trigger is magnetism. A magnetic field may be activated and metal in the portal region responds to the magnetic field. For example, a portal region/lid may be removed from a remainder of the secondary container in a given magnetic field. In various embodiments, the trigger is light. For example, a laser may remove at least a portion of the portal region. As another example, the portal region may be made of a light sensitive material that weakens or breaks in response to light of a specific range of wavelengths.

In various embodiments, the trigger is a physical force. The portal region 128 may have one or more physical characteristics that respond to a physical force (e.g., pressure). For example, the portal region may have a scored edge that breaks when an environment reaches a threshold pressure. The portal region may have a notch that allows the portal region to be torn open in response to a force. In various embodiments, when the top portion 110 is removed from the bottom portion 112, the portal region may be actuated, e.g., torn open. For example, the secondary container may have two points of connection to the apparatus. One point of connection is to top portion 110 and a second point of connection is to bottom portion 112. When a lid (top portion 110) is lifted from a plate (bottom portion 112), a ketchup packet (the secondary container) is torn open to disperse ketchup over a heated food (matter 130). As another example, the physical force may be a vibration or other haptic effect.

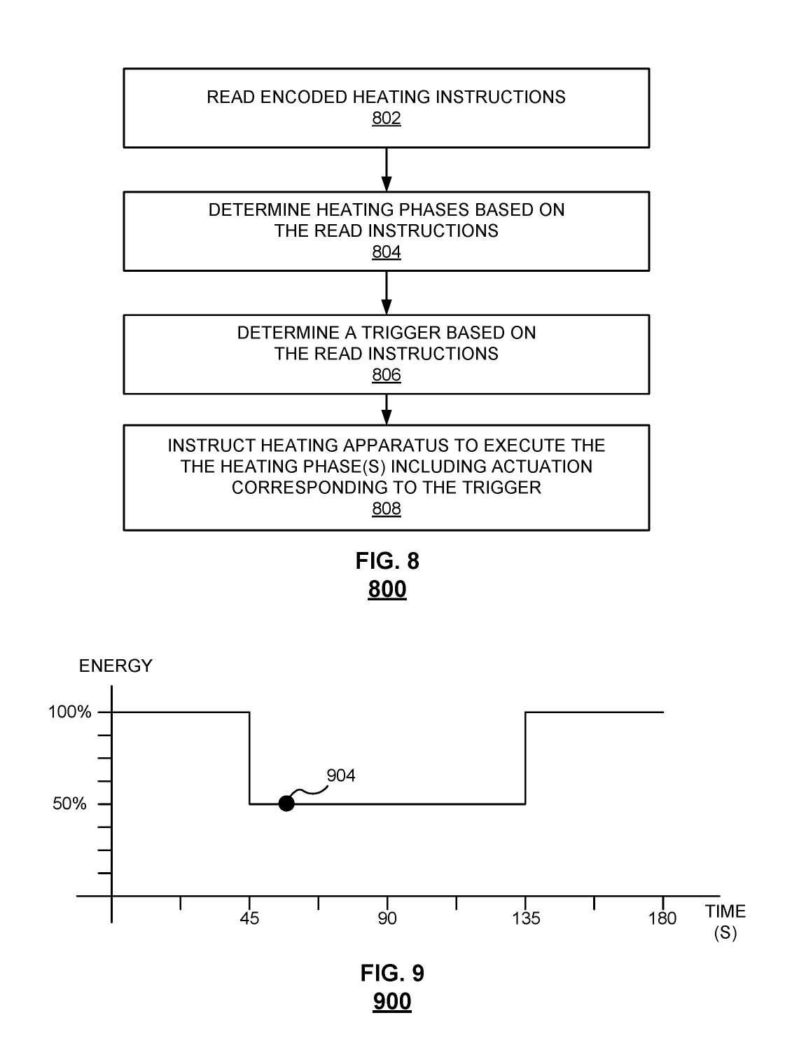

In various embodiments, a portal region may respond to a plurality of triggers. For example, a first portion of the portal region may melt at a first temperature threshold, and a second portion of the portal region may melt at a second temperature threshold. The first melted portion and the second melted portion may merge to form an area from which a secondary substance emerges at a greater rate than the first melted portion alone. Effectively, a smaller amount is dispersed, followed by a larger amount (when the area formed by the first portion and the second portion is created). An example process of dispensing the secondary substance is shown in FIG. 8.

Actuating the portal region at a pre-defined time or in response to a trigger allows for heating methods in certain portions of a heating process that would typically not be possible. For example, a wet heating method can be performed after a dry heating method. Typically, automated cooking systems do not allow wet heating methods after dry methods because dry heating methods are performed without water, and additional water cannot be introduced into the environment after the dry heating methods. Here, in various embodiments, water may be packaged in the secondary container and released at a desired time during a heating process (e.g., towards the end of the heating process), which allows wet heating methods such as steaming even after dry heating methods such as baking and frying.

Examples of materials include one or more (e.g., a mixture) of the following: plastic, metal, wax, and biodegradable material. The material may be formed/structured based on a desired behavior in response to a trigger. For example, where a trigger is heat, the material may be a type of wax that melts at a melting point around the trigger heat threshold. As another example, where the trigger is a magnetic force, the material may be metal having properties that respond to the magnetic force around the trigger threshold. The secondary container may have one region made of a first material and a second region made of a second material. For example, a portal region may be of a material different from a remainder of the secondary container.

In various embodiments, the secondary container may have a plurality of compartments (not shown). Each of the compartments may have a respective portal region. The respective portal region may have a respective trigger, which may be the same or different from one another. For example, a first sauce may be dispersed to a first region of primary heatable load 130 and a second sauce may be dispersed to a second region of primary heatable load 130. As another example, a first group of seasonings may be dispersed to a first region of primary heatable load 130 at a first time and a second group of seasonings may be dispersed to a second region of primary heatable load 130 at a second time. This may accommodate heating recipes that call for adding different types of sauces/seasonings at different times.

In some embodiments, the apparatus includes a handle 122. The handle may facilitate handling and transport of the apparatus. For example, the handle may enable a user to remove the apparatus from a base (e.g., from the heating apparatus 200 of FIG. 2). In various embodiments, the handle is insulated to allow safe handling of the apparatus when the rest of the apparatus is hot. In some embodiments, the handle is collapsible such that the apparatus is easily stored. For example, several apparatus may be stacked. FIG. 1 shows one example of the handle placement. The handle may be provided in other positions or locations.

In some embodiments, the apparatus includes an electronic tag 124. The electronic tag encodes information about the apparatus. By way of non-limiting example, the encoded information includes identification of matter 130, characteristics of the contents, and handling instructions. Using the example of a food package, the electronic tag may store information about the type of food inside the package (e.g., steak, fish, vegetables), characteristics of the food (e.g., age/freshness, texture, any abnormalities), and cooking instructions (e.g., sear the steak at high heat followed by baking at a lower temperature). Although shown below membrane 116, the electronic tag may be provided in other locations such as below handle 122, on a wall of the top portion 110, among other places.

The apparatus 100 may be a variety of shapes and sizes. In some embodiments, the shape of the apparatus is compatible with a heating apparatus such as heating apparatus 200 of FIG. 2. For example, the apparatus may be of a suitable surface area and shape to be heated by apparatus 200.

FIG. 2 is a block diagram illustrating an embodiment of an apparatus 200 for heating. For example, in various embodiments the heating apparatus 200 is adapted to receive an apparatus 230 (also referred to as a chamber) and heat contents of the chamber 230. An example of the chamber 230 is apparatus 100 of FIG. 1. The heating apparatus 200 includes an EM source 202, one or more sensors 204, electronic tag reader 206, and controller 208.

The EM source 202 heats electrically conductive materials. In various embodiments, the EM source is an RF source that provides inductive heating of metals such as ferromagnetic or ferrimagnetic metals. For example, the EM source 202 may include an electromagnet and an electronic oscillator. In some embodiments, the oscillator is controlled by controller 208 to pass an alternating current (AC) through an electromagnet. The alternating magnetic field generates eddy currents in a target such as metal layer 114 of FIG. 1, causing the metal layer to heat. Heating levels and patterns may be controlled by the frequency of the AC and when to apply the AC to the electromagnet as further described herein.

The sensor(s) 204 are adapted to detect characteristics of contents of chamber 230 including any changes that may occur during a heating process. A variety of sensors may be provided including a microphone, camera, thermometer, and/or hygrometer, etc. A microphone may be configured to detect sounds of the matter being heated. A camera may be configured to detect changes in the appearance of the matter being heated, e.g., by capturing images of the matter. A hygrometer may be configured to detect steam/vapor content of the chamber. For example, the hygrometer may be provided near an opening or pressure relief valve such as valve 120 of FIG. 1 to detect moisture escaping the chamber. The information captured by the sensors may be processed by controller 208 to determine a stage in the cooking process or a characteristic of the matter being heated as further described herein. In this example, the sensor(s) are shown outside the chamber 230. In some embodiments, at least some of the sensor(s) are provided inside the chamber 230. In various embodiments, sensor readings are used to determine whether one or more conditions of a trigger to actuate a portal region of a secondary container is met. An example is further described herein with respect to FIG. 8.

The electronic tag reader 206 reads information about contents of the chamber 230 such as characteristics of packaged food. The information encoded in the tag may include properties of the contents, instructions for preparing/heating the contents, etc. In various embodiments, the electronic tag reader is configured to read a variety of tag types including barcodes, QR codes, RFIDs and any other tags encoding information.

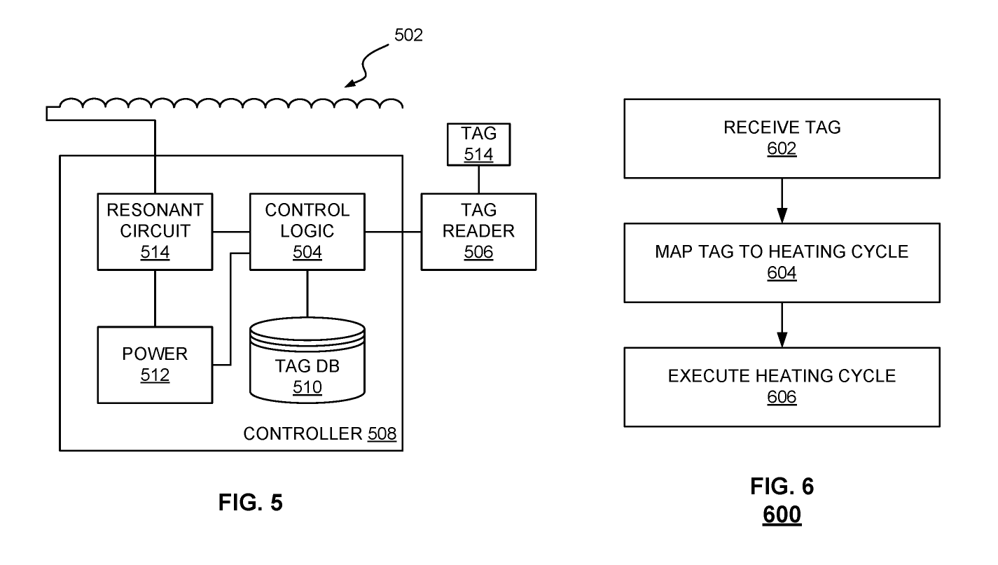

The controller 208 controls operation of the heating apparatus 200. An example of the controller is controller 508 of FIG. 5. In various embodiments, the controller executes instructions for processing contents of chamber 230. In some embodiments, the instructions are obtained from reading an electronic tag of the chamber 230 via the electronic tag reader 206. In some embodiments, the controller requests instructions from a remote server based on the contents. The controller controls the EM source 202 to implement heating levels and patterns, e.g., activating the electromagnet to carry out the heating instructions.

In some embodiments, the apparatus includes one or more network interfaces (not shown). A network interface allows controller 208 to be coupled to another computer, computer network, or telecommunications network using a network connection as shown. For example, through the network interface, the controller 208 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) controller 208 can be used to connect the heating apparatus 200 to an external network and transfer data according to standard protocols. For example, various process embodiments disclosed herein can be executed on controller 208, or can be performed across a network such as the Internet, intranet networks, or local area networks, in conjunction with a remote processor that shares a portion of the processing. Additional mass storage devices (not shown) can also be connected to controller 208 through the network interface.

In some embodiments, the apparatus includes one or more I/O devices (not shown). An I/O device interface can be used in conjunction with heating apparatus 200. The I/O device interface can include general and customized interfaces that allow the controller 208 to send and receive data from other devices such as sensors, microphones, touch-sensitive displays, transducer card readers, tape readers, voice or handwriting recognizers, biometrics readers, cameras, portable mass storage devices, and other computers.

In various embodiments, controller 208 is coupled bi-directionally with memory (not shown), which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on controller 208. Also as is well known in the art, primary storage typically includes basic operating instructions, program code, data and objects used by the controller 208 to perform its functions (e.g., programmed instructions). For example, memory can include any suitable computer-readable storage media, described below, depending on whether, for example, data access needs to be bi-directional or uni-directional. For example, controller 208 can also directly and very rapidly retrieve and store frequently needed data in a cache memory (not shown).

In some embodiments, the controller implements the heating instructions based on sensor readings. The controller may determine that a heating stage is complete, e.g., the food has reached a desired state, based on sensor readings. For example, when a level of moisture inside the chamber 230 drops below a threshold, a Maillard reaction begins and the food becomes browned. The Maillard reaction may be indicated by a characteristic sound (e.g., sizzling). For example, in various embodiments, the controller determines a characteristic of the food being prepared using signals collected by the sensor(s) 204. The controller receives a sensor reading from the microphone and/or other sensors and determines that the Maillard reaction has begun based on the sensor reading meeting a threshold or matching a profile. For example, the color of food may indicate whether the food has been cooked to satisfaction. The controller receives a sensor reading from the camera and/or other sensors and determines that food has been cooked to a desired level of tenderness based on the sensor reading meeting a threshold or matching a profile.

The controller may adjust a heating stage or a heating power level based on sensor readings. For example, in various embodiments at the end of a default heating time indicated by heating instructions, the controller checks sensor readings. The sensor readings indicate that the food is not sufficiently browned. The controller may then extend the heating time such that the food is more browned. The controller may delay actuation of a portal region of a secondary container based on the sensor readings.

In various embodiments, the heating apparatus includes a cradle or support for apparatus 100. For example, the support may be separated from the heating apparatus, the apparatus 100 inserted into the support, and the support returned to the heating apparatus. The support may support a circumference/walls of apparatus 100.

In various embodiments, the heating apparatus includes a switch (not shown). The switch may power on the heating apparatus and/or receive user input to begin a heating process. In various embodiments, the switch is provided with a visual indicator of progress of a heating process. For example, the switch may be provided at the center of a light “bulb,” where the light bulb includes one or more colored lights (e.g., LED lights). The light “bulb” may change colors during the heating process, acting like a timer. For example, at the beginning of a heating process, the bulb is entirely be red. As the heating process progresses, the light gradually turns green (e.g., segment by segment) until the light is entirely green, indicating completion of a heating stage or heating process. The light may gradually turn green segment by segment as if with the sweeping of a second hand of a clock, where a section to the left of the hour and minutes hands is red and a section to the right of the hour and minute hands is green until both hands are at 12:00 and the bulb is entirely green.

In various embodiments, the heating apparatus may include a user interface to display and/or receive user input. For example, a current power/energy level of a heating phase may be displayed on the user interface. In some embodiments, the energy levels are categorized Level 1 to Level 6 and a current power level of a heating phase is displayed on the user interface. The categorization may facilitate user comprehension of the energy level. Power/energy levels may be represented in an analog or continuous manner in some embodiments.

The heating apparatus 200 may be a variety of shapes. For example, apparatus 200 may be around 7 inches in diameter and around 2 inches in height. In some embodiments, the shape of the apparatus is compatible with an apparatus such as chamber 100 of FIG. 1. For example, the apparatus may be of a suitable surface area and shape to heat the contents of chamber 100.

FIG. 3 is a block diagram illustrating an embodiment of an apparatus 300 to apply a secondary substance to matter 330. The apparatus includes a secondary container 326 having a portal region 328. In various embodiments, the apparatus may include one or more of the following components: a metal layer, a membrane, a seal, and a pressure relief valve. These components may function in the same manner as their counterparts described with respect to FIG. 1. For simplicity, these components are not shown.

In this example, the portal region is relatively large. For example, the portal region is 50% or more of a surface of the secondary container. This structuring of the portal region may find application in food preparation such as dispersing pasta sauce on pasta or providing water/steam to a food. In various embodiments, the portal region may be relatively small (e.g., less than 50% of a surface of the second container). Smaller portal regions may allow more directed dispersal of the secondary substance. An example of a relatively small portal region in shown in FIG. 1.

In various embodiments, when conditions of a trigger are met during a heating process, the portal region 328 is actuated to allow a secondary substance to be dispersed from the portal region to primary heatable load 330. An example of a heating process and triggering of the portal region is shown in FIG. 8.

FIG. 4 is a block diagram illustrating an embodiment of an apparatus 400 to apply a secondary substance to matter 430. The apparatus includes a secondary container 426 having a portal region 428. In various embodiments, the apparatus may include one or more of the following components: a metal layer, a membrane, a seal, and a pressure relief valve. These components may function in the same manner as their counterparts described with respect to FIG. 1. For simplicity, these components are not shown.

In this example, the secondary container 426 is provided substantially below primary heatable load 430. This position may allow a secondary substance to evaporate to the primary heatable load. When conditions of a trigger are met during a heating process, the portal region 428 is actuated to allow a secondary substance to be dispersed from the portal region to primary heatable load 430. An example of a heating process and triggering of the portal region is shown in FIG. 8. For example, the primary heatable load may be steamed when water is released from portal region 428.

In various embodiments, the secondary container may be provided in various locations substantially below the primary heatable load, including between the load and a metal layer, directly below the load, and/or embedded in a bottom portion (e.g., 112 of FIG. 1).

FIG. 5 is a block diagram of an embodiment of a controller 508 for a heating apparatus. For example, the controller may be provided in heating apparatus 200 of FIG. 2. The controller 508 includes control logic 504, a tag database 510, resonant circuit 514, and power 512. In this example, the controller 508 is communicatively coupled to EM source 502 and tag reader 506.

The tag reader 506 reads a tag 514. The tag 514 may encode information about contents of a chamber. An example of tag reader 506 is electronic tag reader 206 of FIG. 2.

The control logic 504 is configured to receive tag information from the tag reader 506 and determine one or more heating cycles based on the tag information. In some embodiments, the control logic determines heating cycle(s) by looking up an association between the tag information and stored heating cycles. For example, the control logic may determine heating cycle(s) adapted to properties of a chamber in which the heatable load is provided and/or characteristics of the heatable load. In various embodiments, the control logic executes one or more processes described herein including process 600 of FIG. 6 and process 800 of FIG. 8.

In some embodiments, the control logic is implemented by one or more processors (also referred to as a microprocessor subsystem or a central processing unit (CPU)). For example, the control logic 504 can be implemented by a single-chip processor or by multiple processors. In some embodiments, a processor is a general purpose digital processor that controls the operation of the heating apparatus 200. Using instructions retrieved from memory, the processor controls the reception and manipulation of input data, and the output and display of data on output devices (not shown).

The tag database 510 stores associations between heatable loads and heating cycles. For example, energy level, duration, and other properties of heating cycles may be stored in association with a load or characteristic(s) the load. In various embodiments, the associations are pre-defined and loaded into the database. In various embodiments, the associations are refined based on machine learning, user feedback, and/or sensor readings of heatable load properties before, during, or after a heating cycle. Although shown as part of the controller 508, the tag database may instead be external to the controller.

The resonant circuit 514 controls the EM source 502. An example of a resonant circuit is shown in FIG. 5. In some embodiments, the resonant circuit 514 has an integrated EM source 502, e.g., an inductor coil (not shown). In some embodiments, the EM source is a separate element from the resonant circuit 514.

The power 512 is input to the resonant circuit 514. In various embodiments, power 512 is a DC source. The DC source may be an internal or external DC source or may be adapted from an external AC source. Although shown as an internal source, the power may instead be external to the controller 508.

In operation, tag reader 506 read tag information from tag 514, and sends the information to the control logic 504. The control logic 504 maps the received tag information to one or more heating cycles using associations stored in tag database 510. The control logic 504 then instructs the resonant circuit 514 to execute the heating cycles. For example, the control logic 504 may also control when power 512 is provided to the resonant circuit 514. Resonant circuit 514 then activates the EM source 502.

FIG. 6 is a flowchart illustrating an embodiment of a process 600 to operate an automatic heating system. In various embodiments, the process 600 may be implemented by a processor such as control logic 504 of FIG. 5.

A tag is received (602). In various embodiments, the tag is an electronic tag associated with a heatable load. Tag 124 of FIG. 1 is an example of a tag encoding information about matter 150. Returning to FIG. 6, the tag is mapped to a heating cycle (604). In various embodiments, the tag is mapped by looking up an association between the tag and heating cycles. The heating cycles may be adapted for characteristics of a heatable load. The heating cycle may be defined by a duration and an energy level as further described herein. Upon determination of one or more heating cycles, the heating cycle(s) is executed (606). For example, in various embodiments control logic instructs a resonant circuit, e.g., 514 of FIG. 5, to drive an EM source, e.g., 502 of FIG. 5.

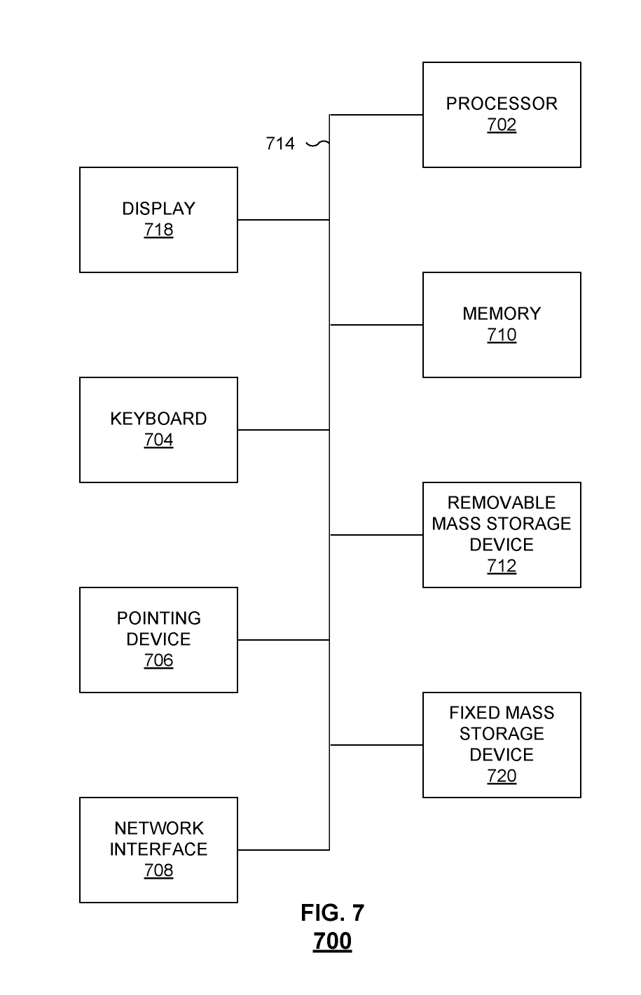

FIG. 7 is a functional diagram illustrating a programmed computer system for applying a secondary substance to a primary heatable load in accordance with some embodiments. As will be apparent, other computer system architectures and configurations can be used to decode a custom heating program, where the program includes an instruction to apply a secondary substance to a primary heatable load. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In some embodiments, processor 702 includes and/or is used to execute/perform the processes described herein with respect to FIGS. 6 and 8.

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or uni-directional. For example, processor 702 can also directly and very rapidly retrieve and store frequently needed data in a cache memory (not shown).

A removable mass storage device 772 provides additional data storage capacity for the computer system 700, and is coupled either bi-directionally (read/write) or uni-directionally (read only) to processor 702. For example, storage 772 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storage 772, 720 generally store additional programming instructions, data, and the like that typically are not in active use by the processor 702. It will be appreciated that the information retained within mass storage 772 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

FIG. 8 is a flowchart illustrating an embodiment of a process 800 to apply a secondary substance to a primary heatable load. In various embodiments, the application of the secondary substance is part of a coded custom heating program adapted for contents of a package such as matter 130 of FIG. 1. In various embodiments, the process 800 may be implemented by a processor such as controller 208 of FIG. 2, or controller 508 of FIG. 5, or processor 702 of FIG. 7.

At 802, encoded heating instructions are read. In some embodiments, the instructions are obtained from reading an electronic tag. For example, in various embodiments, an electronic tag reader such as reader 206 of FIG. 2 scans an electronic tag 124 of FIG. 1. In some embodiments, heating instructions are embedded in the electronic tag and an Internet connection is not needed to heat a load using the heating instructions. In some embodiments, instructions are requested from a remote server based on an identification of the packaged food.

At 804, heating phases are determined based on the read instructions. The instructions may include a heating schedule having one or more phases. In various embodiments, each phase is characterized by a duration and/or an energy level. For example, the heating instructions may be provided as a recipe or schedule in which the food is heated at a particular temperature/energy level for a defined duration of time. In various embodiments, the heating schedule may include an event/trigger. The trigger may have conditions, which, if satisfied, cause a secondary substance to be applied to a primary heatable load. FIG. 9 is an example of a heating schedule including a trigger 904.

In various embodiments, the duration and/or an energy level for a phase may be adjusted based on the user input. In some cases, one or more phases may be added or removed based on the user input. For example, various options for food preparation may be displayed on the touch screen. One or more options may be selected via the user interface. In response to user selection of the preparation option, the controller adjusts a heating schedule to produce the desired result. In some embodiments, the controller adjusts a trigger to produce the desired result. For example, a user may indicate that the user prefers relatively salty food. This may cause a secondary container with salt to trigger earlier such that relatively more salt is dispersed. As another example, one user may indicate that the user prefers melty cheese toppings while a second user indicates that less-melty cheese toppings is preferable. For the first user, cheese may be dispersed from the secondary container earlier compared with dispensing of cheese for the second user. That is, the trigger for dispersing cheese is earlier for the first user or the trigger for dispersing cheese is at a higher temperate for the first user.

At 806, a trigger is determined based on the read instructions. For example, the instructions may include conditions for a trigger (timing, temperature, state of food, etc.). The trigger may include instructions for releasing a secondary substance, e.g., actuating a portal region in response to a trigger such that at least a portion of contents of a secondary container is automatically dispersed to a primary heatable load from the portal region. Referring to FIG. 1, the trigger causes a secondary substance to emerge from portal region 128. Examples of triggers are further described with respect to FIG. 1.

At 808, a heating apparatus is instructed to execute the heating phases including actuation corresponding to the trigger. In various embodiments, an electromagnetic (EM) source is instructed to energize at a specific time to carry out the heating phases. For example, EM source 202 may be energized at an appropriate frequency and time to effect the pre-defined energy level for a pre-defined duration for a phase as further described herein with respect to FIG. 2. In various embodiments, typical recipes are completed within three minutes and may include one or more phases and one or more triggers. In various embodiments, physical force is applied in response to a trigger. In various embodiments, directed heat is applied to a secondary container in response to a trigger. In some instances, the choice of material is selected to respond to a trigger.

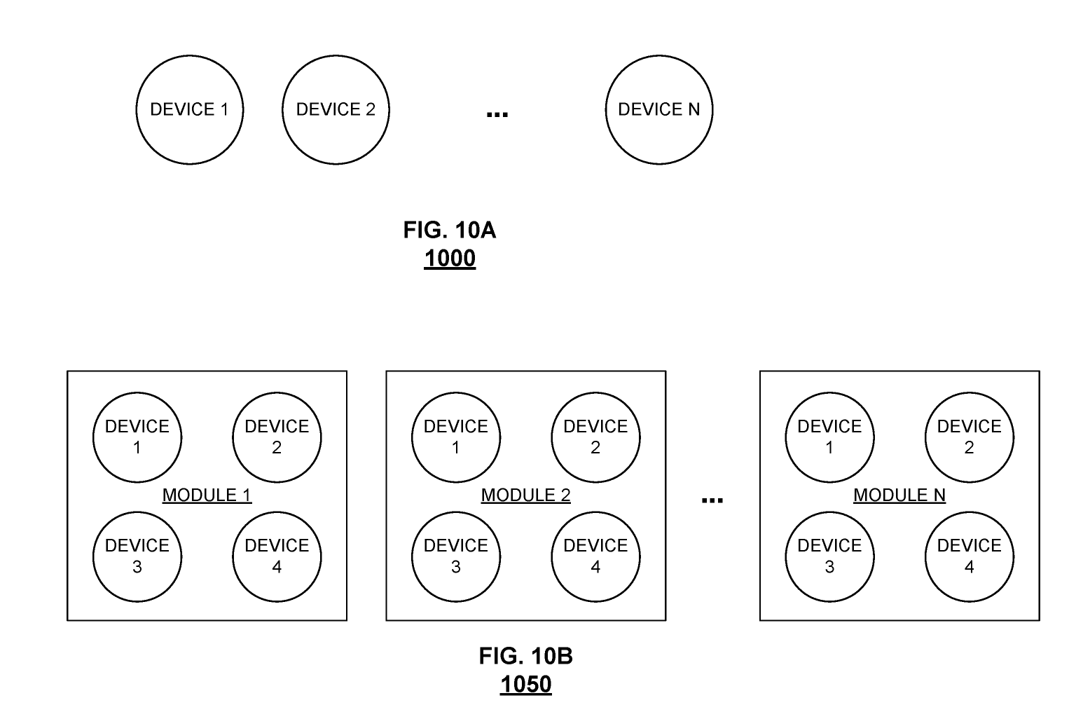

In various embodiments, a heating apparatus that is part of a system of a plurality of heating apparatus is instructed to execute the determined heating phases in a coordinated manner. For example, the heating apparatus may delay beginning of a first heating phase such that the heating process ends at substantially the same time as another heating apparatus. As another example, the heating apparatus may delay beginning of a first heating phase such that the heating apparatus ends at a pre-defined time before or after at least one other heating apparatus. An example of a cooking system with a plurality of cooking modules is further described herein with respect to FIGS. 10A and 10B.

FIG. 9 is a block diagram illustrating an embodiment of a heating schedule including a trigger for applying a secondary substance to a primary heatable load. The heating schedule may be determined by decoding a custom heating program. In this example, the heating schedule is represented by a graph, where the x-axis is time in seconds and the y-axis is energy level. The energy level is given by the energy that a heating apparatus is capable of providing, e.g., field per unit volume of the material being heated up, heat per unit volume of material, temperature, etc. This example cooking schedule takes three minutes and includes three phases: first searing at 100% energy for 45 seconds, then steaming at 50% energy for 90 seconds, and finally finishing at 100% energy for 45 seconds. In this example, there is an event/trigger 904 at around 67.5 seconds. The trigger in this example is a time. At the given time, a secondary substance (e.g., water) is released. This allows the food to be steamed even if there is no initial water content or all of the water is gone by the end of the first phase (e.g., ending at 45 seconds). That is, additional water is introduced by trigger 904. In various embodiments, the trigger may include checking for conditions based on sensor readings in the environment of the primary heatable load. Using the example of a portal region that is actuated by heat, at a trigger event, heat may be applied resulting in actuation of the portal region some time after the heat is applied.

FIG. 10A is a block diagram illustrating an embodiment of a modular heating system 1000. The system 1000 includes a plurality of sub-units (labelled as “devices”). In this example, the sub-units of the system are heating apparatus, e.g., N heating apparatus. An example of a heating apparatus is heating apparatus 200 of FIG. 2. In various embodiments, the sub-units are communicatively coupled to at least their adjacent sub-units. For example, the sub-units may communicate by wired or wireless means such as Bluetooth®, Wi-Fi®, and/or other local area network protocols. For example, in various embodiments, the sub-units each have a network interface such as the network interface described with respect to FIG. 2.

The sub-units may be configured to coordinate operation such that the system operates as a single unit. For example, one of the sub-units may be appointed as a master and communicate with the other slave sub-units of the system. If the master is removed from the system, another sub-unit may be appointed as the master. As another example, each of the sub-units may be instructed to operate (e.g., delay beginning of a heating cycle) by a central server.

The system 1000 is expandable and accommodates sub-units that may be added or removed after an initial set-up. For example, the heating apparatus need not be acquired at the same time. When a heating apparatus is added to the system, the heating apparatus is automatically configured to communicate and coordinate with the other heating apparatus as further described herein. When a heating apparatus is removed from the system, the system is automatically updated.

In various embodiments, one or more sub-units of system 1000 is configured to coordinate meal preparation. For example, the heating apparatus may be configured to finish heating at the same time. Those heating apparatus with contents having shorter heating times may delay the start time such that more than one of the heating apparatus finish at the same time. Suppose Device 1 is instructed to cook steak, which takes 3 minutes, Device 2 is instructed to cook spinach, which takes 1 minute, and Device N is instructed to cook mashed potatoes, which takes 1.5 minutes. Device 1 begins first, 1.5 minutes later, Device N begins, and 30 seconds after Device N begins, Device 2 begins. Thus, Devices 1, 2, and N will finish heating at the same time. One or more of the heating processes used by Devices 1, 2, . . . N may include providing a secondary substance to a primary heatable load. For example, the steak may have a sauce that is dispersed from a respective secondary container in response to a first trigger, the spinach may have seasoning that is dispersed from a respective secondary container in response to a second trigger, and the mashed potatoes may have butter that is that is dispersed from a respective secondary container in response to a third trigger.

As another example, the devices may be configured to finish heating at staggered times. Using the same example in which Device 1 is instructed to cook steak, which takes 3 minutes, Device 2 is instructed to cook spinach, which takes 1 minute, and Device N is instructed to cook mashed potatoes, which takes 1.5 minutes, suppose mashed potatoes need more time to cool down. Devices 1 and 2 may be configured to finish at the same time, and Device N may be configured to finish 1 minute before Devices 1 and 2 finish. Device 1 begins first, 0.5 minutes later, Device N begins, and 1.5 minutes after Device N begins, Device 2 begins. Thus, Devices 1 and 2 will finish heating at the same time (3 minutes after Device 1 began) and Device N will finish heating 1 minute before Devices 1 and 2 are finished.

FIG. 10B is a block diagram illustrating an embodiment of a modular heating system 1050. The system 1050 includes a plurality of sub-units (labelled as “devices”). In this example, the sub-units of the system are modules, e.g., N modules. Each of the modules includes four heating apparatus, Device 1 to Device 4. An example of a heating apparatus is heating apparatus 200 of FIG. 2. In various embodiments, the sub-units are communicatively coupled to at least their adjacent sub-units. For example, the sub-units may communicate by wired or wireless means such as Bluetooth®, Wi-Fi®, and/or other local area network protocols. For example, in various embodiments, the sub-units each have a network interface such as the network interface described with respect to FIG. 2.

In various embodiments, the modules may be configured to coordinate operation of constituent heating apparatus. For examples, Device 1 to Device 4 are configured to finish heating at the same time or pre-defined staggered finish times. In various embodiments, the modules may be configured to coordinate operation with each other. For example, Modules 1 to N are coordinated to finish heating at the same time or pre-defined staggered finish times.

Suppose system 1050 is preparing a meal for two people, where each meal includes four courses. Each of the courses may be packaged in a chamber such as apparatus 100 of FIG. 1. In some embodiments, the chambers may be loaded into the devices at the same time and configured to be finished heating at pre-defined times (e.g., at the same time or pre-selected staggered times).

There are a variety of ways to load the chambers into the devices/modules. In a first example, each of the courses for the first person is inserted into a respective device in Module 1. Each of the courses for the second person is inserted into a respective device in Module 2. For example, Device 1 in each module receives a package for a starter, Device 2 in each module receives a package for an intermediate course, Device 3 in each module receives a package for a main course, and Device 4 in each module receives a package for a dessert. The packages may all be inserted into the cookers at the same time.

In a second example, courses of the same type are inserted into the same module. For example, a starter package is inserted into Device 1 and Device 2 of Module 1, an intermediate course package is inserted into Device 3 and Device 4 of Module 1, a main course package is inserted into Device 1 and Device 2 of Module 2, and a dessert package is inserted into Device 3 and Device 4 of Module 2.

In operation, the modules may coordinate to finish cooking the starter first, finish cooking the intermediate course 10 minutes after cooking of the starter is completed, finish cooking the main course 15 minutes after cooking of the intermediate course is completed, and finish cooking the dessert 20 minutes after cooking of the main course is completed. The modules may factor in the time is takes to prepare each of the courses in determining when to begin cooking each of the courses to meet the defined finish time. In various embodiments, one or more of the heating processes used by Devices 1, 2, . . . N may include providing a secondary substance to a primary heatable load in response to a respective trigger. The provisioning of the secondary substance to the primary heatable load may be coordinated. The end times may be adapted to a user, e.g., based on usage habits and/or preferences provided by a user or associated with a user profile. In various embodiments, the heating apparatus is configured for use in a top-loading manner (e.g., like loading matter into a pot or pan on a cooktop). In various embodiments, the heating apparatus is configured for use in a side-loading manner (e.g., like loading matter into a conventional oven).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An apparatus comprising:
a receptacle for a primary heatable load; and
a secondary container having a portal region, wherein:
the portal region is provided below the primary heatable load;
the portal region is actuated in response to a trigger such that at least a portion of contents of the secondary container is automatically dispersed to the primary heatable load from the portal region, and
the trigger includes an image of the primary heatable load meeting a profile.

2. The apparatus of claim 1, wherein:
the receptacle includes a top portion and a bottom portion adapted to receive the top portion to define a space enclosed within the top portion and the bottom portion, and
the secondary container is provided in the defined space.

3. The apparatus of claim 1, wherein contents of the secondary container includes a sauce.

4. The apparatus of claim 1, wherein contents of the secondary container includes water.

5. The apparatus of claim 1, wherein the trigger includes temperature meeting a threshold.

6. The apparatus of claim 1, wherein the trigger includes pressure meeting a threshold.

7. (canceled)

8. The apparatus of claim 1, wherein the trigger includes water content in an environment of the primary heatable load meeting a threshold.

9. The apparatus of claim 1, wherein the trigger includes a magnetic field.

10. The apparatus of claim 1, wherein the trigger includes a physical force.

11. The apparatus of claim 1, wherein the secondary container is plastic.

12. The apparatus of claim 1, wherein the secondary container is metal.

13. The apparatus of claim 1, wherein the secondary container is wax.

14. The apparatus of claim 1, wherein the secondary container is a biodegradable material.

15. The apparatus of claim 1, wherein the automatic dispersal of at least a portion of contents of the secondary container is in a pre-defined direction.

16. The apparatus of claim 1, wherein the automatic dispersal of at least a portion of contents of the secondary container is substantially aligned with an actuator of the portal region.

17. The apparatus of claim 1, wherein the secondary container is adapted for a heating apparatus, wherein the heating apparatus includes:
an electromagnetic (EM) source; and
a controller configured to:
receive data associated with the primary heatable load;
determine heating instructions based at least in part on the received data; and
control the EM source based on the determined heating instructions, wherein the heating instructions includes the trigger for actuation of the portal region to automatically disperse at least a portion of contents of the secondary container to the primary heatable load.

18. The apparatus of claim 1, wherein the secondary container is adapted for a heating apparatus, and the heating apparatus includes:
an electromagnetic (EM) source; and
a controller configured to:
use a tag reader to read heating instruction data encoded in an electronic tag;
determine heating phases based on the read heating instruction data;
determine a trigger based on the read heating instruction data, wherein the trigger actuates a portal region to automatically disperse at least a portion of contents of a secondary container to a primary heatable load; and
automatically control a heating apparatus to execute the determined heating phases including actuation of the portal region in response to the trigger.

19. The apparatus of claim 18, wherein the automatic control of the heating apparatus includes:
receiving at least one sensor reading; and
if the at least one sensor reading indicates that a condition for the trigger has been met, actuating the portal region to automatically disperse at least a portion of contents of the secondary container to the primary heatable load.

20. A computer program product embodied in a non-transitory computer readable storage medium and comprising computer instructions for:
using a tag reader to read heating instruction data encoded in an electronic tag;
determining, by a processor, heating phases based on the read heating instruction data;
determining, by the processor, a trigger based on the read heating instruction data, wherein the trigger includes an image of a primary heatable load meeting a profile and the trigger actuates a portal region to automatically disperse at least a portion of contents of a secondary container to a primary heatable load; and
automatically controlling a heating apparatus to execute the determined heating phases including actuation of the portal region in response to the trigger, wherein the portal region is provided below the primary heatable load.

21. The apparatus of claim 1, wherein the trigger includes a change in appearance of the primary heatable load based at least in part on captured images of the primary heatable load.

22. The apparatus of claim 1, wherein the secondary container is adapted for a heating apparatus and the heating apparatus includes an image capture device configured to capture the image of the primary heatable load.
